(19) United States
(12) Patent Application Publication
(10) Pub. No.: US 2006/0044299 A1
(43) Pub. Date: Mar. 2, 2006

(54) System and method for compensating for a fabrication artifact in an electronic device

(76) Inventors: Jian Wang, Goleta, CA (US); Gang Yu, Santa Barbara, CA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/930,936

(22) Filed: Aug. 31, 2004

(51) Int. Cl. G09G 5/00

(52) U.S. Cl. 345/207

(57) ABSTRACT

A method can be used for compensating for a fabrication artifact in an electronic device that has either at least one radiation-emitting electronic component or at least one radiation-sensing electronic component. The method includes receiving a signal from the at least one radiation-emitting or radiation-sensing electronic component, respectively and counter processing the signal based at least partially on calibration data for the electronic device. The electronic device can include radiation-emitting electronic components or radiation-sensing electronic components of different types.

### FIELD OF THE INVENTION

The invention relates in general to electronic devices, and more particularly to electronic devices having fabrication artifacts.

### BACKGROUND INFORMATION

Electronic devices, including organic electronic devices, continue to be used more extensively in everyday life. Examples of organic electronic devices include Organic Light-Emitting Diode (“OLED”) flat panel displays (FPDs). OLED FPDs have many advantages over liquid crystal display (LCD) technology such as thickness, brightness, viewing angle, power consumption, ease of fabrication, etc. A typical OLED display can include a glass substrate on which a conductor layer, an organic layer, and a transparent conductor layer can be deposited. Moreover, there are two types of OLED technologies: “small molecule” technology and “polymer” based technology.

In the “small molecule” technology, the deposition of the organic materials on the substrate can be achieved generally by vacuum sublimation. On the other hand, in the “polymer” based technology, the organic materials can be deposited on the substrate using an ink-jet process, a spin coat process, or other similar liquid deposition processes well known in the art. Due to the nature of the deposition processes and other limiting factors, a finished OLED display panel can exhibit non-uniform radiation emission or radiation sensing. FIG. 1 illustrates an electronic device 100 having a plurality of fabrication artifacts 102. The fabrication artifacts 102 can appear as lines, e.g., vertical lines, across the electronic device 100. The fabrication artifacts 102 can be oriented in any direction across the electronic device 100 and can have nearly any shape. Moreover, the fabrication artifacts 102 can stretch partially or completely across the electronic device 100. In other words, at “full-on”, with all pixels in the display at the same forward bias, the fabrication artifacts 102 can cause some areas of the OLED display panel to emit radiation with less intensity than other areas of the OLED display panel. Similar effects occur with electronic devices that operate outside the visible light spectrum, and with electronic devices that are used to sense radiation.

One way to correct the non-uniformity of radiation emission can include improving the technology of the fabrication processes and the overall structure of the display panels. However, advances in fabrication processes can take many years.

### SUMMARY OF THE INVENTION

A method can be used for compensating for a fabrication artifact in an electronic device that has at least one radiation-emitting electronic component. In one embodiment, the method includes receiving a signal from the at least one radiation-emitting electronic component and counter processing the signal based at least partially on calibration data for the electronic device.

In an alternative embodiment, a method can be used for compensating for a fabrication artifact in an electronic device that has at least one radiation-sensing electronic component. Particularly, the method includes receiving a signal from the at least one radiation-sensing electronic component and counter processing the signal based at least partially on calibration data for the electronic device.

The foregoing general description and the following detailed description are exemplary and explanatory only and are not restrictive of the invention, as defined in the appended claims.

### BRIEF DESCRIPTION OF THE DRAWINGS

The invention is illustrated by way of example and not limitation in the accompanying figures.

FIG. 1 is a diagram depicting a plurality of fabrication artifacts in an electronic device.

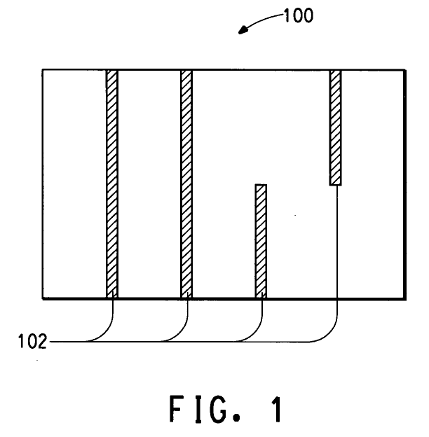

FIG. 2 is a diagram depicting a first embodiment of a system for compensating for a fabrication artifact in an electronic device.

FIG. 3 is a flow chart to illustrate a first embodiment of a method for compensating for a fabrication artifact in an electronic device.

FIG. 4 is a flow chart to illustrate a first embodiment of a method for calibrating an electronic device to determine the location of fabrication artifacts.

FIG. 5 is a diagram depicting an electronic device to which a method for compensating for a fabrication artifact in an electronic device has been applied.

FIG. 6 is a diagram depicting a second embodiment of a system for compensating for a fabrication artifact in an electronic device.

FIG. 7 is a flow chart to illustrate a second embodiment of a method for compensating for a fabrication artifact in an electronic device.

FIG. 8 is a flow chart to illustrate a second embodiment of a method for calibrating an electronic device to determine the location of fabrication artifacts.

Skilled artisans appreciate that features in the figures are illustrated for simplicity and clarity and have not necessarily been drawn to scale. For example, the dimensions of some of the features in the figures may be exaggerated relative to other features to help to improve understanding of embodiments of the invention.

### DETAILED DESCRIPTION

A method can be used for compensating for a fabrication artifact in an electronic device that has at least one radiation-emitting electronic component. In one embodiment, the method can include receiving a signal from the at least one radiation-emitting electronic component. The method can also include counter processing the signal based at least partially on calibration data for the electronic device.

In another particular embodiment, the electronic device can include radiation-emitting electronic components of different types. Moreover, in a particular embodiment, receiving the signal can further include receiving signals corresponding to streams and each stream can correspond to one type of radiation-emitting electronic component. Also, in a particular embodiment, counter processing can further include counter processing each stream for each type of radiation-emitting electronic component at least partially based on the calibration data.

In yet another particular embodiment, the calibration data can include at least one emission intensity setting for the at least one radiation-emitting electronic component. In a particular embodiment, the method can further include activating one or more of the at least one radiation-emitting electronic components, and collecting emission intensity data from the one or more of the at least one radiation-emitting electronic components. At least partially based on a reference emission intensity, the method can include adjusting one or more emission intensity settings for the one or more of the at least one radiation-emitting electronic components.

In still another particular embodiment, the method can further include interlacing at least two different streams to yield an output signal. Further, in another particular embodiment, the method can include scaling the output signal to a resolution of the electronic device. In yet another particular embodiment, the method can also include adjusting a panel control signal to yield an image having a desired emission intensity. In yet still another particular embodiment, the emission intensity data can be collected using a digital camera having a resolution that is substantially equal to or greater than a number of pixels within the electronic device.

In a particular embodiment, the at least one radiation-emitting electronic components can include red radiation-emitting electronic components, blue radiation-emitting electronic components, green radiation-emitting electronic components, or a combination thereof. Moreover, in a particular embodiment, receiving and counter processing can be performed for the red radiation-emitting electronic components. Further, in a particular embodiment, receiving and counter processing can be performed for the blue radiation-emitting electronic components separately from the red radiation-emitting electronic components. In yet another particular embodiment, receiving and counter processing can be performed for the green radiation-emitting electronic components separately from the red and blue radiation-emitting electronic components.

In still another particular embodiment, each radiation-emitting electronic component can include an organic electronic device that has an organic active layer. Also, in a particular embodiment, the electronic device can include an array of radiation-emitting electronic components and radiation-sensing electronic components.

In an alternative embodiment, a method can be used for compensating for a fabrication artifact in an electronic device that has at least one radiation-sensing electronic component. Particularly, the method can include receiving a signal from the at least one radiation-sensing electronic component. The method can also include counter processing the signal based at least partially on calibration data for the electronic device.

In another particular embodiment, the calibration data can include at least one sensitivity setting for the at least one radiation-sensing electronic component. In yet another particular embodiment, the method can include irradiating the radiation-sensing electronic component with an irradiation source that produces a known radiation flux, and collecting radiation sensitivity data from one or more of the at least one radiation-sensing electronic components. At least partially based on a reference radiation sensitivity, the method can include, adjusting a radiation sensitivity setting for the one or more of the at least one radiation-sensing electronic components.

In another particular embodiment, the reference radiation sensitivity can be determined at least partially based on a known radiation flux that reaches the one or more of the at least one radiation-sensing electronic components. In still another particular embodiment, the method can include placing a radiation source near the electronic device and the radiation source can be configured to produce the radiation flux at the one or more of the at least one radiation-sensing electronic components. In yet another particular embodiment, the electronic device can include an array of radiation-sensing electronic components.

In yet still another particular embodiment, each radiation-sensing electronic component can include an organic electronic device that has an organic active layer. Also, in another particular embodiment, the electronic device can include an array of radiation-sensing electronic components and radiation-emitting electronic components.

The detailed description first addresses Definitions and Clarification of Terms followed by Systems and Methods for Fabrication Artifact Compensation; Other Embodiments; and finally, Advantages.

### 1. Definitions and Clarification of Terms

The term “calibration data” is intended to mean one or more pieces of information collected regarding an electronic device that can be accessed, e.g., by a process unit, in order to ensure more uniform performance of the electronic device.

The term “counter processing” is intended to mean an act of manipulating or adjusting one or more characteristics of a signal based at least in part on calibration data previously collected in order to account for variation in the one or more characteristics due to variations between electronic components within an electronic device. For example, a red/green/blue (RGB) signal can be counter processed in order to display an image using an electronic device that is closer to the intended, desired, or actual image.

The term “digital camera” is intended to mean a camera that takes pictures without using film (e.g., negatives).

The term “electronic component” is intended to mean a lowest level unit of a circuit that performs an electrical function. An electronic component may include a transistor, a diode, a resistor, a capacitor, an inductor, or the like. An electronic component does not include parasitic resistance (e.g., resistance of a wire) or parasitic capacitance (e.g., capacitive coupling between two conductors connected to different electronic components where a capacitor between the conductors is unintended or incidental).

The term “electronic device” is intended to mean a collection of circuits, electronic components, or combinations thereof that collectively, when properly connected and supplied with the appropriate potential(s), performs a function. An electronic device may include or be part of a system. Examples of electronic devices include displays, sensor arrays, computer systems, avionics, automobiles, cellular phones, and many other consumer and industrial electronic products.

The term “emission intensity” is intended to mean a measure of the strength of an emitted radiation, e.g., from a radiation-emitting electronic component or other radiation source. For example, when referring to the visible light spectrum, the emission intensity can be the luminance of one or more electronic components within a display device and can be given as candelas per meter squared (cd/m²).

The term “fabrication artifact” is intended to mean a manufacturing non-uniformity in an electronic device created during the construction of the electronic device. For example, a fabrication artifact can be caused by an anomaly in a spin coating process, a sputtering process, a vapor deposition process, a screen coating process, an ink jetting process, etc. Moreover, a fabrication artifact can be a difference in material thickness, a difference in material consistency, a difference in material concentration, a difference in material composition, a combination thereof, etc. The term “fabrication artifact” as used herein is not related to the normal aging processes of pixels (e.g., luminance degradation, shift in color purity, etc.).

The term “interlacing” is intended to mean the act of combining two or more streams to yield a single signal. For example, a stream corresponding to one or more red radiation-emitting electronic components, a stream corresponding to one or more green radiation-emitting electronic components, and a stream corresponding to one or more blue radiation-emitting electronic components can be interlaced with one another to yield a full color or red/green/blue (RGB) video signal.

The term “organic electronic device” is intended to mean a device including one or more semiconductor layers or materials. Organic electronic devices have one or more organic active layers and such devices include: (1) devices that convert electrical energy into radiation (e.g., an light-emitting diode, light emitting diode display, or diode laser or lighting panel), (2) devices that detect signals through electronics processes (e.g., photodetectors (e.g., photoconductive cells, photoresistors, photoswitches, phototransistors, phototubes), infrared (“IR”) detectors, biosensors), (3) devices that convert radiation into electrical energy (e.g., a photovoltaic device or solar cell), and (4) devices that include one or more electronic components that include one or more organic semiconductor layers (e.g., a transistor or diode). The active layer includes at least one material that exhibits electronic or electro-radiative properties.

The term “panel control signal” is intended to mean a signal, e.g., a current, a voltage, an optical signal, or any combination thereof, that can be used to control one or more operations of an electronic device, e.g., the emission intensity of a display of the electronic device.

The term “radiation-emitting electronic component” is intended to mean an electronic component, which when properly biased, can generate radiation at a targeted wavelength or spectrum of wavelengths. The radiation may be within the visible-light spectrum or outside the visible-light spectrum (UV or IR). A light-emitting diode is an example of a radiation-emitting component.

The term “resolution” is intended to mean a measure of the amount of detail that can be shown in an image produced by a display or an electronic device or a digital camera. Resolution is typically given by the number of pixels in each direction of an image, e.g., 1024×768.

The term “radiation-sensing electronic component” is intended to mean an electronic component, which when properly biased, can sense radiation at a targeted wavelength or spectrum of wavelengths. The radiation may be within the visible-light spectrum or outside the visible-light spectrum (UV or IR). IR sensor is an example of a radiation-sensing component.

The term “scaling” is intended to mean the act of changing the size of a graphical object, e.g., the visual output of a display device, without changing the shape, e.g., the ratio of length to width, of the graphical object.

The term “setting” is intended to mean a control value for an electronic component or a circuit. When a radiation-emitting electronic component is used to create radiation, the setting can be the strength of the signal applied to the radiation-emitting electronic component.

The term “signal” is intended to mean a current, a voltage, an optical signal, or any combination thereof. The signal can be a voltage or current from a power supply or can represent, by itself or in combination with other signal(s), data or other information. Optical signals can be based on pulses, intensity, or a combination thereof. Signals may be substantially constant (e.g., power supply voltages) or may vary over time (e.g., one voltage for on and another voltage for off).

The term “stream”, when referring to a signal, is intended to mean a set of signals representing at least one image to be displayed or to be captured. For example, red/green/blue video signals includes a first stream corresponding to one or more red radiation-emitting electronic components, a second stream corresponding to one or more green radiation-emitting electronic components, and a third stream corresponding to one or more blue-radiation emitting electronic components. In one embodiment, the stream may represent a single image (i.e., a frame) or a motion picture (e.g., a set of frames that illustrate movement).

As used herein, the terms “comprises,” “comprising,” “includes,” “including,” “has,” “having” or any other variation thereof, are intended to cover a non-exclusive inclusion. For example, a process, article, or apparatus that comprises a list of features is not necessarily limited only those features but may include other features not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the organic light-emitting diode display, photodetector, photovoltaic, and semiconductor arts.

### 2. Systems and Methods for Fabrication Artifact Compensation

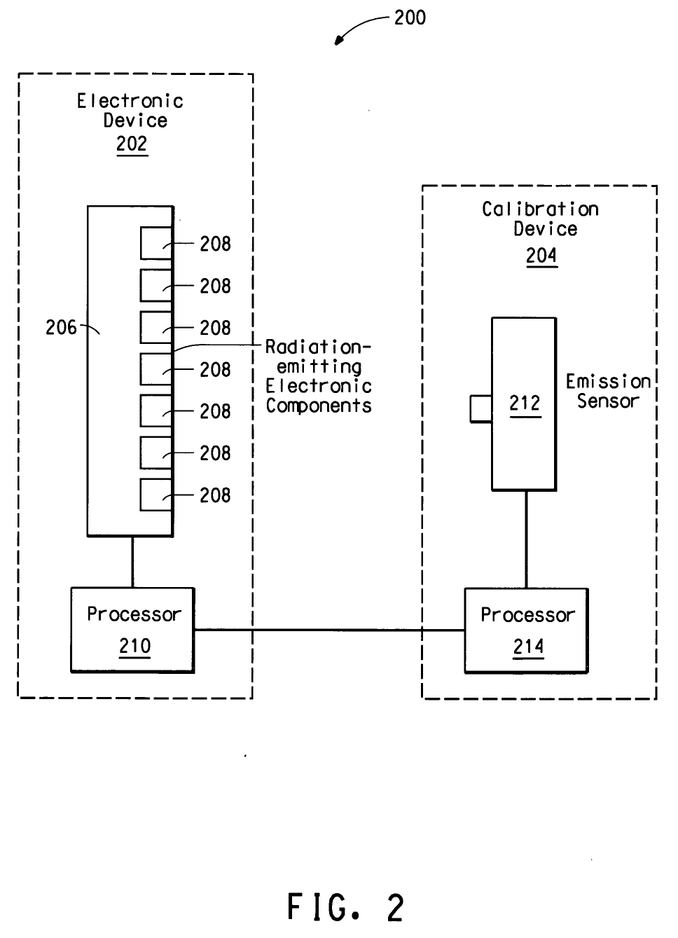

FIG. 2 through FIG. 8 portray various systems and methods that can be useful for compensating for fabrication artifacts in electronic devices. Fabrication artifacts can be caused by an anomaly in a spin coating process, a sputtering process, a vapor deposition process, a screen coating process, an ink jetting process, etc. A fabrication artifact can be a difference in material thickness, a difference in material consistency, a difference in material concentration, a difference in material composition, a combination thereof, etc.

Referring to FIG. 2, in one embodiment, a system for compensating for a fabrication artifact in an electronic device is illustrated and is generally designated 200. As depicted in FIG. 2, the system includes an electronic device 202 and a calibration device 204. In an illustrative embodiment, the electronic device 202 includes a display panel 206 having an array of radiation-emitting electronic components 208. Moreover, a first processor 210 is connected to the display panel 206.

In FIG. 2, the calibration device 204 includes an emission sensor 212 and a second processor 214. In an illustrative embodiment, the emission sensor 212 is a digital camera having a number of pixels substantially equal to, or greater than, the number of radiation-emitting electronic components 208 in the display panel 206. In an illustrative embodiment, the first processor 210, the second processor 214, or both can include logic that can be executed, as described below, in order to compensate for one or more fabrication artifacts that are present in the electronic device 202, e.g., in the display panel 206. In another embodiment, the digital camera may be replaced by a plurality of emission sensors. In a more specific embodiment, the number of emission sensors may be the same as the number of pixels within the display panel 206.

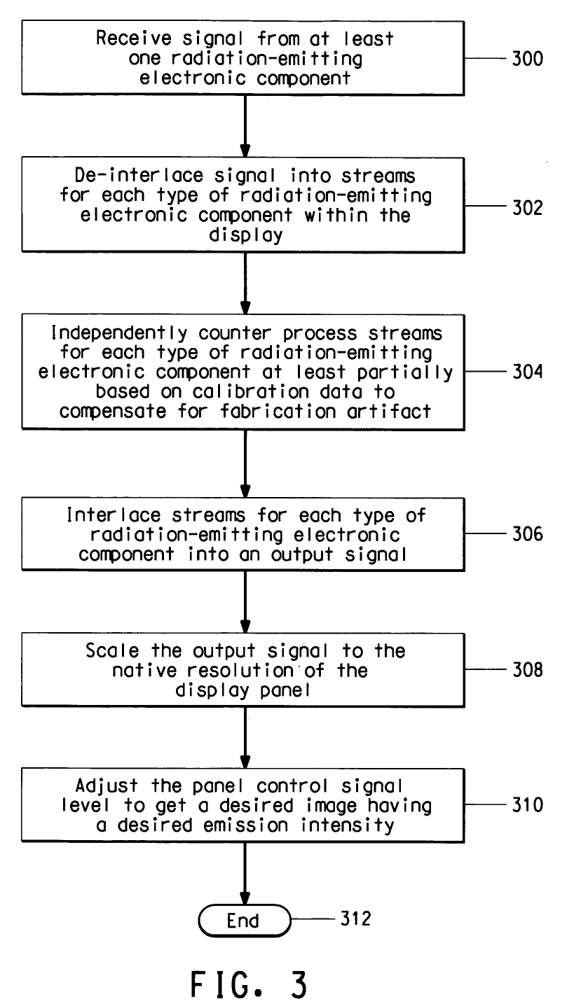

FIG. 3 illustrates one embodiment of a method for compensating for a fabrication artifact in an electronic device, e.g., the electronic device 202 shown in FIG. 2. Beginning at block 300, a signal is received from at least one radiation-emitting electronic component 208 (FIG. 2). At block 302, in one embodiment, the signal is de-interlaced into streams for each type of radiation-emitting electronic component 208 (FIG. 2) within the display panel 206 (FIG. 2). In a particular embodiment, the different types of radiation-emitting electronic components include red radiation-emitting electronic components, blue radiation-emitting electronic components, and green radiation-emitting electronic components.

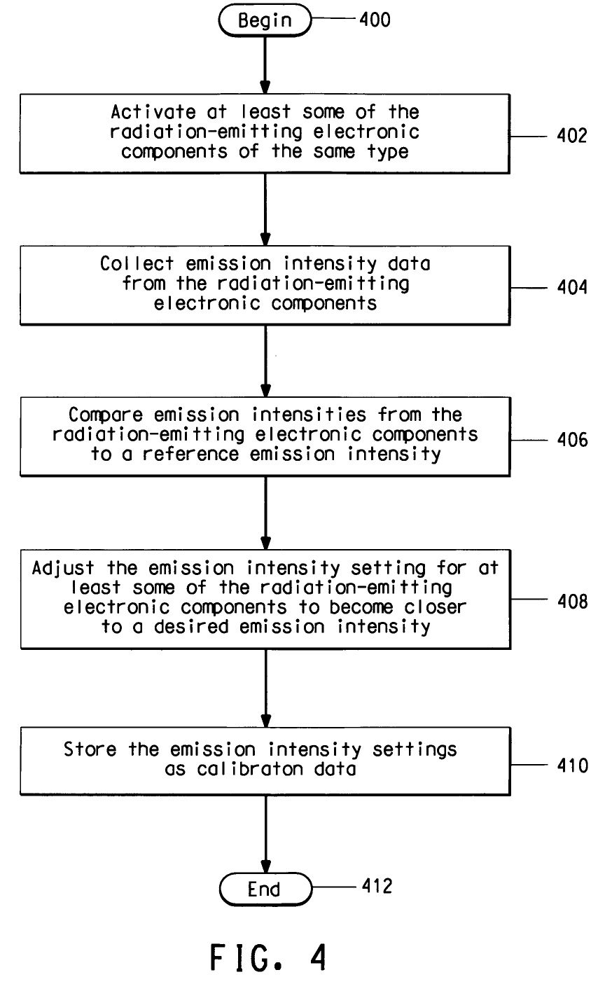

Moving to block 304, the streams for each type of radiation-emitting electronic component are independently counter processes based on calibration data previously collected (and described in greater detail below in FIG. 4) to compensate for one or more fabrication artifacts present in the display panel 206 (FIG. 2). In a particular embodiment, the calibration data is collected using the emission sensor 212 (FIG. 2) as described in detail below. Proceeding to block 306, in one embodiment, the streams are interlaced for each type of radiation-emitting electronic component to yield an output signal. The output signal is scaled to the native resolution of the display panel 206 (FIG. 2) at block 308. Thereafter, at block 310, the panel control signal level is adjusted to get a desired image having a desired emission intensity. The logic then ends at state 312.

In a particular embodiment, the display panel 206 (FIG. 2) is monochromatic, i.e., all of the radiation-emitting electronic components 208 (FIG. 2) are substantially the same and emit radiation having substantially the same wavelength. As such, the signal from a monochromatic display does not need to be de-interlaced and later interlaced as described above.

Referring now to FIG. 4, calibration logic is illustrated and begins at block 400. Moving to block 402, at least some of the radiation-emitting electronic components 208 (FIG. 2) of the same type are activated. In one embodiment, one radiation-emitting electronic component 208 (FIG. 2), a row, a column, a section, a quadrant, a combination thereof, or the entire array of radiation-emitting electronic components 208 (FIG. 2) is activated. At block 404, emission intensity data from the radiation-emitting electronic component(s) is collected using the emission sensor 212 (FIG. 2). In an illustrative embodiment, the emission sensor 212 (FIG. 2) is a digital camera and the intensity data can be collected by capturing and recording an image of the display panel 206 (FIG. 2) while the red radiation-emitting electronic components, the blue radiation-emitting electronic components, the green radiation-emitting electronic components, or a combination thereof, are activated.

Proceeding to block 406, emission intensities from the radiation-emitting electronic components 208 (FIG. 2) are compared to a reference emission intensity for each type of radiation-emitting electronic components. The reference emission intensity can be predetermined or an averaged value based on collected data. The averaged value can be an average, a geometric mean, or median of emission data collected from radiation-emitting electronic components 208 (FIG. 2) of the same type, e.g., red radiation-emitting electronic components, green radiation-emitting electronic components, or blue radiation-emitting electronic components. In an illustrative embodiment, the images of the radiation-emitting electronic components can be examined in order to determine which areas within the display panel 206 (FIG. 2) are brighter or darker than the reference emission intensity. At block 408, the emission intensity setting for at least some of the radiation emitting electronic components is adjusted in order to become closer to a desired emission intensity. Thereafter, at block 410, the emission intensity settings are stored as calibration data. The logic then ends at state 412.

In an illustrative embodiment, all or a portion of the logic depicted in FIG. 3 and FIG. 4 can be executed at the first processor 210 (FIG. 2), the second processor 214 (FIG. 2), or a combination thereof. Additionally, in a particular embodiment, either one of the processors 210, 214 can be omitted from the system 200 (FIG. 2).

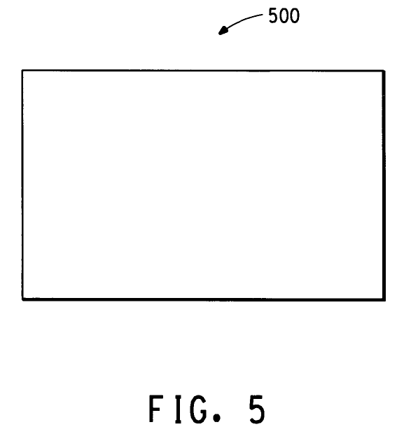

FIG. 5 illustrates an electronic device, designated 500, to which the above methods can be applied. Once the electronic device 500 is calibrated as shown in FIG. 4 and the method for compensating for a fabrication artifact in an electronic device shown in FIG. 3 is applied thereto, the electronic device 500, when activated, will appear to have substantially zero fabrication artifacts that are visible via the display panel 206 (FIG. 2). In other words, the fabrication artifacts still physically exist, but the changes in the signals that are applied to the radiation-emitting electronic components 208 (FIG. 2) effectuated during compensation cause those fabrication artifacts to not appear during the display of graphics at the display panel 206 (FIG. 2).

After reading this specification, skilled artisans may realize that depending on the colors displayed by the display panel 206 (FIG. 2), different areas of the display panel 206 (FIG. 2) may appear lighter or darker. As such, in a particular embodiment, the calibration logic is performed for each type of radiation-emitting electronic component, e.g., red, blue, and green, in order to collect calibration data for each. Moreover, the method for compensating for a fabrication artifact is also performed for each type of radiation-emitting electronic components.

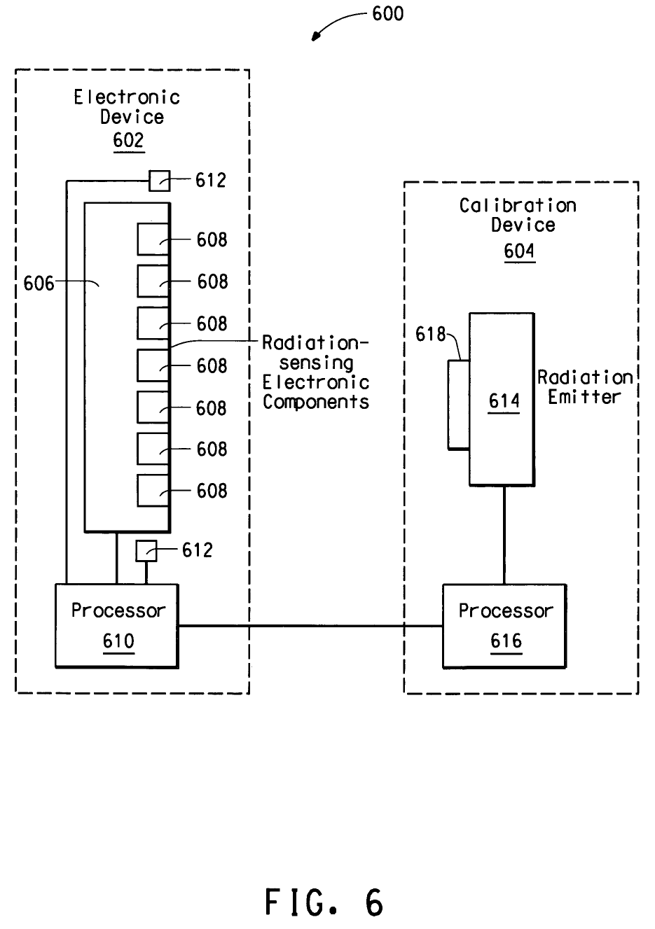

Referring to FIG. 6, an alternative embodiment of a system for compensating for a fabrication artifact in an electronic device is illustrated and is generally designated 600. As depicted in FIG. 6, the system 600 includes an electronic device 602 and a calibration device 604. In an illustrative embodiment, the electronic device 602 includes a sensor array 606 that has an array of radiation-sensing electronic components 608. A first processor 610 is connected to the sensor array 606. Moreover, two reference sensors 612 are connected to the first processor 610. The reference sensors 612 are placed adjacent to the outer perimeter of the sensor array 606 near the radiation-sensing electronic components 608.

As further shown in FIG. 6, the calibration device 604 includes a radiation emitter 614 and a second processor 616 connected thereto. A lens 618 is disposed adjacent to the radiation emitter 614 in order to focus radiation from the radiation emitter 614 toward the sensor array 606 in order to substantially uniformly irradiate the sensor array 606. In one illustrative embodiment, the lens 618 can be a collimating lens, a Fresnel lens, etc. However, the calibration device 604 can further include a reflector, e.g., a parabolic reflector, around the radiation emitter 614 in order to provide substantially uniform radiation across the sensor array 606. In a particular embodiment, the reference sensors 612 are disposed so that they are also irradiated with the substantially uniform radiation from the radiation emitter 614. Further, the radiation emitter 614 can emit visible light, ultraviolet light, infrared light, heat, etc.

In alternative embodiments, more radiation emitters 614 can be used. Further, a lens, a reflector, or both may not be used. In one particular embodiment, the number of radiation emitters may be substantially the same as the number of radiation sensing electronic components 608.

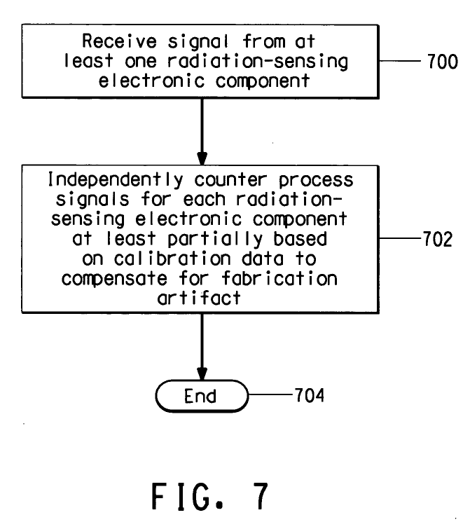

Referring now to FIG. 7, an alternative embodiment of a method for compensating for a fabrication artifact in an electronic device is depicted and commences at block 700 where a signal is received by at least one radiation-sensing electronic component 608 (FIG. 6). In one embodiment, a signal is received by a row, a column, a section, a quadrant, a combination thereof, or the entire array of radiation-sensing electronic components 608 (FIG. 6). At block 702, the signals for each radiation-sensing electronic component 608 (FIG. 6) are independently processed at least partially based on calibration data in order to compensate for a fabrication artifact. The logic ends at state 704.

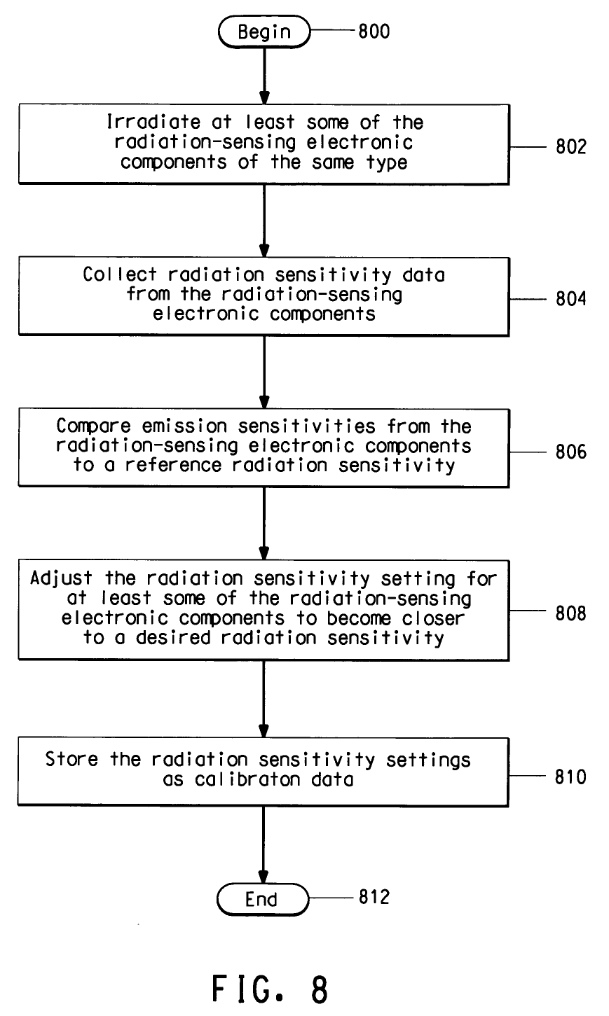

FIG. 8 depicts an alternative embodiment of calibration logic that begins at block 800. At block 802, at least some of the radiation-sensing electronic components of the same type are irradiated. In one embodiment, a row, a column, a section, a quadrant, a combination thereof, or the entire array of radiation-sensing electronic components 608 (FIG. 6) are irradiated. Moving to block 804, radiation sensitivity data is collected from the radiation-sensing electronic component(s) 608 (FIG. 6). The emission sensitivities from the radiation-sensing electronic components are compared to a reference radiation sensitivity at block 806. In a particular embodiment, the reference radiation sensitivity is determined using the reference radiation-sensing electronic components 612 (FIG. 6). However, the reference radiation sensitivity can be predetermined. Next, at block 808, the radiation sensitivity setting for at least some of the radiation-sensing electronic components are adjusted in order to become closer to a desired radiation sensitivity. At block 810, the radiation sensitivity settings are stored as calibration data. The logic then ends at state 812.

In an illustrative embodiment, all or a portion of the logic depicted in FIG. 7 and FIG. 8 can be executed at the first processor 610 (FIG. 6), the second processor 616 (FIG. 6), or a combination thereof. Additionally, in a particular embodiment, either one of the processors 610, 616 can be omitted from the system 600 (FIG. 6).

### 3. Other Embodiments

The systems and methods described above can be with nearly any type of electronic device including one or more radiation-emitting electronic components or radiation-sensing electronic components in order to compensate for a fabrication artifact caused by a fabrication anomaly. In a particular embodiment, a fabrication artifact is present in an organic electronic device having at least one organic active layer. Moreover, the systems and methods can be used to compensate for nearly any type of anomaly caused by fabrication. Fabrication artifacts can occur particularly in the formation of layers using a liquid deposition technique. Moreover, fabrication artifacts can occur during any fabrication activity including etching, sealing, etc. A fabrication artifact can be, for example, a difference in material thickness, a difference in material consistency, a difference in material concentration, a difference in material composition, a combination thereof, etc. Also, the fabrication artifact can be caused by an anomaly in a spin coating process, a sputtering process, a vapor deposition process, a screen coating process, an ink jetting process, etc. In one embodiment, the display panel is part of a full color active matrix organic light emitting diode display.

### 4. Advantages

Embodiments described herein have benefits that can be applied to conventional devices without changing fabrication processes. For example, the methods outlined in FIG. 3 and FIG. 7, can be used to compensate for fabrication artifacts that occur in highly controlled manufacturing environments. The methods described herein can be implemented in a cost-effective manner during a testing phase before the electronic devices are shipped to consumers.

Note that not all of the activities described above in the general description or the examples are required, that a portion of a specific activity may not be required, and that further activities may be performed in addition to those described. Still further, the order in which each of the activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method for compensating for a fabrication artifact in an electronic device comprising at least one radiation-emitting electronic component, wherein the method comprises:
receiving a signal from the at least one radiation-emitting electronic component; and
counter processing the signal based at least partially on calibration data for the electronic device.

2. The method of claim 1, wherein:
the electronic device comprises radiation-emitting electronic components of different types;
receiving the signal further comprises receiving signals corresponding to streams, wherein each stream corresponds to one type of radiation-emitting electronic component; and
counter processing further comprises counter processing each stream for each type of radiation-emitting electronic component at least partially based on the calibration data.

3. The method of claim 1, wherein the calibration data comprises at least one emission intensity setting for the at least one radiation-emitting electronic component.

4. The method of claim 3, further comprising determining the calibration data by:
activating one or more of the at least one radiation-emitting electronic components;
collecting emission intensity data from the one or more of the at least one radiation-emitting electronic components; and
at least partially based on a reference emission intensity, adjusting one or more emission intensity settings for the one or more of the at least one radiation-emitting electronic components.

5. The method of claim 4, further comprising interlacing at least two different streams to yield an output signal.

6. The method of claim 5, further comprising scaling the output signal to a resolution of the electronic device.

7. The method of claim 6, further comprising adjusting a panel control signal to yield an image having a desired emission intensity.

8. The method of claim 4, wherein the emission intensity data is collected using a digital camera having a resolution substantially equal to or greater than a number of pixels within the electronic device.

9. The method of claim 1, wherein the at least one radiation-emitting electronic components comprises red radiation-emitting electronic components, blue radiation-emitting electronic components, green radiation-emitting electronic components, or a combination thereof.

10. The method of claim 9, wherein:
receiving and counter processing is performed for the red radiation-emitting electronic components;
receiving and counter processing is performed for the blue radiation-emitting electronic components separately from the red radiation-emitting electronic components; and
receiving and counter processing is performed for the green radiation-emitting electronic components separately from the red and blue radiation-emitting electronic components.

11. The method of claim 1, wherein each radiation-emitting electronic component comprises an organic electronic device comprising an organic active layer.

12. The method of claim 1, wherein the electronic device comprises an array of radiation-emitting electronic components and radiation-sensing electronic components.

13. A method for compensating for a fabrication artifact in an electronic device comprising at least one radiation-sensing electronic component, wherein the method comprises:
receiving a signal from the at least one radiation-sensing electronic component; and
counter processing the signal based at least partially on calibration data for the electronic device.

14. The method of claim 12, wherein the calibration data comprises at least one sensitivity setting for the at least one radiation-sensing electronic component.

15. The method of claim 14, further comprising determining the calibration data by:
irradiating the radiation-sensing electronic component with an irradiation source that produces a known radiation flux;
collecting radiation sensitivity data from one or more of the at least one radiation-sensing electronic components; and
at least partially based on a reference radiation sensitivity, adjusting a radiation sensitivity setting for the one or more of the at least one radiation-sensing electronic components.

16. The method of claim 15, wherein the reference radiation sensitivity is determined at least partially based on a known radiation flux reaching the one or more of the at least one radiation-sensing electronic components.

17. The method of claim 15, further comprising placing a radiation source near the electronic device, wherein the radiation source is configured to produce the radiation flux at the one or more of the at least one radiation-sensing electronic components.

18. The method of claim 13, wherein the electronic device comprises an array of radiation-sensing electronic components.

19. The method of claim 13, wherein each radiation-sensing electronic component comprises an organic electronic device comprising an organic active layer.

20. The method of claim 13, wherein the electronic device comprises an array of radiation-sensing electronic components and radiation-emitting electronic components.
